(19) United States
(12) Patent Application Publication
(10) Pub. No.: US 2023/0168362 A1
(43) Pub. Date: Jun. 1, 2023

(54) SYSTEM AND METHOD FOR MONITORING A PROJECTILE

(71) Applicant: AOB Products Company, Columbia, MO (US)

(72) Inventors: Kyle Martin, Columbia, MO (US); James Tayon, Moberly, MO (US); Curtis Smith, Columbia, MO (US); Michael Cottrell, Ashland, MO (US); Michael Lindsay, Columbia, MO (US); Jarrod Grove, Columbia, MO (US); Kyle Mauzey, Columbia, MO (US)

(73) Assignee: AOB Products Company, Columbia, MO (US)

(21) Appl. No.: 18/060,829

(22) Filed: Dec. 1, 2022

Related U.S. Application Data
(60) Provisional application No. 63/264,738, filed on Dec. 1, 2021.

(51) Int. Cl. G01S 13/58; G01S 7/02; G01S 7/24; G01P 3/68

(52) U.S. Cl. CPC G01S 13/588; G01S 7/027; G01S 7/24; G01P 3/685

(57) ABSTRACT

A system for monitoring at least one projectile during flight. The system includes a radar apparatus, a trigger, and a processor. The radar apparatus transmits a radar signal that includes a base radar frequency signal with a frequency shift. The radar signal has a signal profile in a direction of a chosen target and reflects off the projectile(s) traveling through the signal profile toward the target. The radar apparatus receives at least one reflected signal from the projectile(s). The trigger is operably coupled to the radar apparatus to automatically initiate operation of the radar apparatus. The processor collects data from the radar apparatus and calculates velocity of the projectile(s) based thereon. The present disclosure further provides a method of monitoring the projectile(s) during flight with the system. The present disclosure further provides a chronograph system with a housing, aiming device with a peep sight, and a trigger.

### CROSS-REFERENCE TO RELATED APPLICATION

This application claims the benefit of U.S. Provisional Patent Application Ser. No. 63/264,738, filed on Dec. 1, 2021, the entire disclosure of which is incorporated herein by reference.

### FIELD OF THE DISCLOSURE

The present disclosure generally relates to a radar chronograph for monitoring projectiles.

### BACKGROUND OF THE DISCLOSURE

Existing ballistic chronographs are used to measure velocity of a projectile in flight by sending the projectile within a portion, or window, of the ballistic chronograph. A common projectile is a bullet from a firearm or an arrow from a bow. Screen and optical “shoot through” ballistic chronographs require the ballistic chronograph to be set up in a line of fire and the projectile must shoot through a portion of the chronograph in order to measure velocity of a bullet. This presents a number of limitations: 1) a user is not safe when setting up the ballistic chronograph as the ballistic chronograph needs to be placed in front of line of fire and the chronograph itself is not safe from damage as the ballistic chronograph is within the firing line, 2) shotguns cannot be easily chronographed as the shot spread may damage the chronograph, and 3) velocity is measured at only one distance, such that determinations of muzzle velocity or trajectory must rely on assumptions or secondary measuring devices.

A radar-based ballistic chronograph has been used to solve some of the screen and optical “shoot through” ballistic chronographs limitations. The radar-based ballistic chronograph 1) can be set up on or behind the firing line 2) is not damaged by a shotgun spread, and 3) can measure multiple velocities (e.g., at multiple distances) to make an improved approximation of velocity trajectory of a muzzle. However, existing implementation of radar-based ballistic chronographs exhibit further limitations. Conventional radar-based ballistic chronographs rely on Doppler radar to measure the velocity of the “target” (bullet, shot, or other projectile being measured) versus time, but determining muzzle velocity and trajectory based on this measured velocity is prone to error because such determinations rely on an inferred initial time and depend on the setup of the radar-based ballistic chronograph. Second, only one “target” velocity can be measured. This limits the ability to extract, for example, meaningful shotgun patterning.

### SUMMARY OF THE DISCLOSURE

An aspect of the present disclosure provides a system for monitoring at least one projectile during flight. The system includes a radar apparatus, a trigger, and a processor. The radar apparatus transmits a radar signal having a base radar frequency signal with a frequency shift. The radar signal has a signal profile in a direction of a chosen target. The radar signal reflects off at least one projectile traveling through the signal profile toward the target. The radar apparatus further receives at least one reflected signal from the projectile. The reflected signal and the radar signal have radar data. The trigger is operably coupled to the radar apparatus to automatically initiate operation of the radar apparatus to transmit the radar signal and initiate operation of the radar apparatus to receive the reflected signal. The processor collects the radar data and calculates velocity of the projectile based thereon.

In another aspect, the present disclosure provides a method of monitoring at least one projectile during flight with the system. The method includes triggering the radar apparatus to transmit the radar signal in the direction of the chosen target, generating the radar signal from the radar apparatus in response to the triggering, acquiring data from the radar signal from the radar apparatus, and acquiring data from the reflected signal off the projectile passing through the signal profile of the radar signal. The method further includes binning the radar data for use of determining the velocity of the projectile.

In yet another aspect, the present disclosure provides a system for monitoring a plurality of projectiles in a shot cloud during flight. The system includes a radar apparatus transmit a radar signal having a base radar frequency signal with a frequency shift. The radar signal has a signal profile in a direction of a chosen target. The radar signal reflects off the plurality of projectiles within the shot cloud traveling through at least a portion of the signal profile toward the chosen target. The radar apparatus receives reflected signals from the plurality of projectiles within the shot cloud. The reflected signals and the radar signal have radar data. The system further includes a trigger operably coupled to the radar apparatus to automatically initiate operation of the radar apparatus to transmit the radar signal and receive the reflected signals. The system further includes a processor that collects the radar data and calculates velocity of two or more of the plurality of projectiles within the shot cloud based thereon.

In yet another aspect, the present disclosure provides a chronograph system for monitoring at least one projectile during flight. The chronograph system includes a housing, an aiming device, and a trigger. The housing contains a processor configured to calculate a velocity of the projectile based on monitoring the projectile during flight. The aiming device is coupled to the housing and has a peep sight through which an operator is able to view an intended path of the projectile. The trigger is operably coupled to the processor and automatically initiates operation of the processor for calculating the velocity of the projectile.

### BRIEF DESCRIPTION OF THE DRAWINGS

FIG. 1 is a front view of a projectile monitoring system of the present disclosure;

FIG. 2 is a graphical illustration of a shot cloud monitored by the system of FIG. 1;

FIG. 3 is a schematic of the system of the present disclosure;

FIG. 4 is an alternative schematic of the system of the present disclosure;

FIG. 5 is an interior view of a back housing portion of a housing of the system of FIG. 1;

FIG. 6 is an interior view of a front housing portion of the housing of the system of FIG. 1;

FIG. 7 is a front diagrammatic view of the of the system aligned with a firearm;

FIG. 8 is a top diagrammatic view of the of a signal profile and a projectile directed towards a chosen target;

FIG. 9 is a top diagrammatic view of the of the system coupled to the firearm by a trigger;

FIG. 10 is a front diagrammatic view of the of the system coupled to the firearm by the trigger;

FIG. 11 illustrates an example signal profile of a radar signal;

FIG. 12 is a cross-section perspective of the signal profile of the radar signal at the chosen target;

FIG. 13 is a front diagrammatic view of a shot cloud pattern on the chosen target;

FIG. 14 is a graphical representation of a phase shift of the radar signal and a reflected signal;

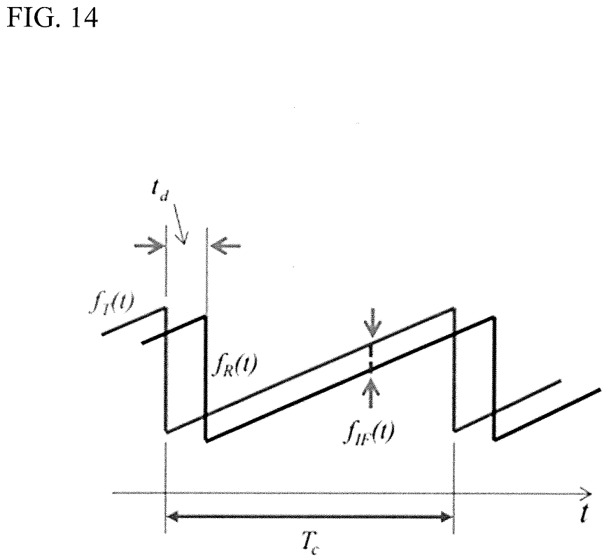

FIG. 15A is an illustration of a relative range for a number of pellets within the shot cloud; and

FIG. 15B is an illustration of an example shot pattern of pellets within the shot cloud at a given distance.

### DETAILED DESCRIPTION OF THE DISCLOSURE

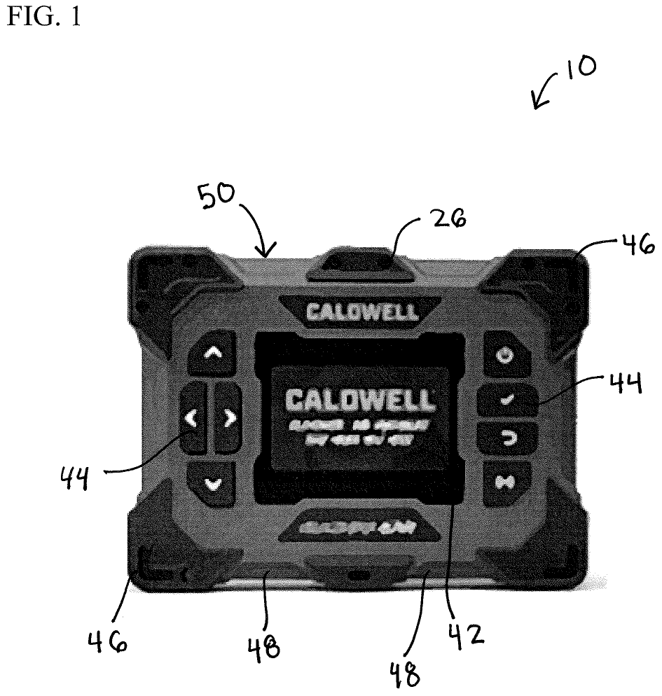

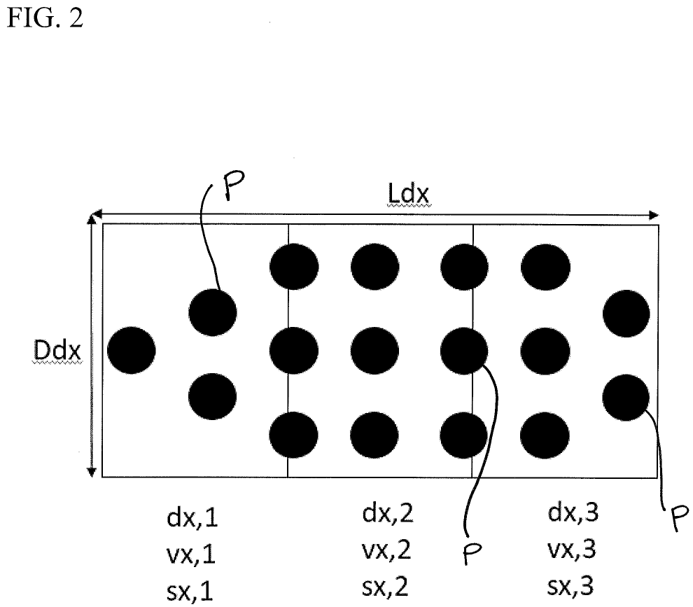

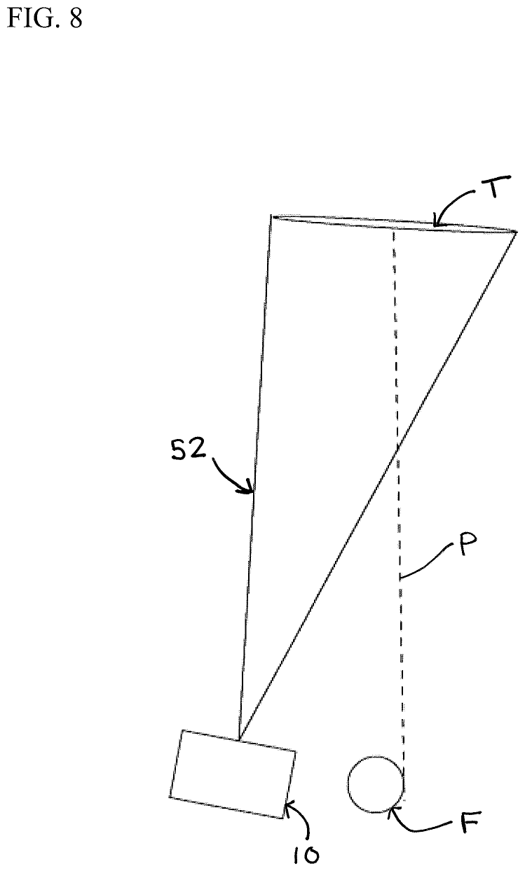

Referring to FIG. 1, one embodiment of the system for monitoring at least one projectile according to the teachings of the present disclosure is generally indicated at reference numeral 10. The system 10 is designed for monitoring at least one projectile P (FIGS. 2 and 8) during flight. The projectile P may include a plurality of projectiles (e.g., a plurality of pellets being fired simultaneously). Referring to FIG. 2, in an embodiment, a plurality of pellets of a shot cloud monitored during flight with the shot cloud beginning flight at a same initial point. The projectiles P may initiate from a firearm F (e.g., a pellet) or a bow (e.g., an arrow) towards a shooting target. However, other projectiles may be monitored without departing from the present disclosure.

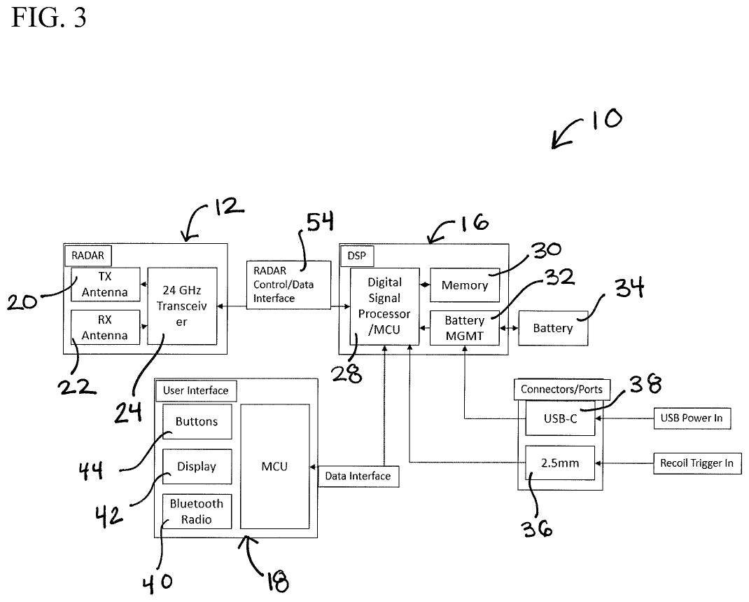

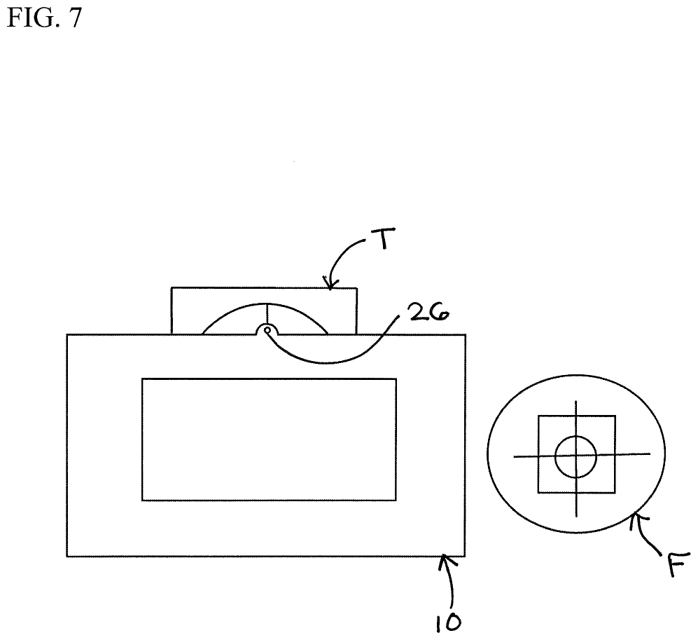

Referring to FIG. 3, the system 10 includes a radar apparatus, generally indicated at reference number 12, a trigger, generally indicated at reference number 14, and a processor, generally indicated at reference number 16. The system 10 may further include a user interface, generally indicated at reference number 18. In an embodiment, the radar apparatus 12 includes a transmitter antenna 20 and a receiver antenna 22 coupled to a transceiver 24. The radar apparatus 12 is operably coupled to the processor 16 through a radar control and a data interface 54. The system 10 includes an aiming device having a peep sight 26 (FIGS. 1 and 7) through which an operator is able to use to align the system 10 with a chosen target T (FIG. 7).

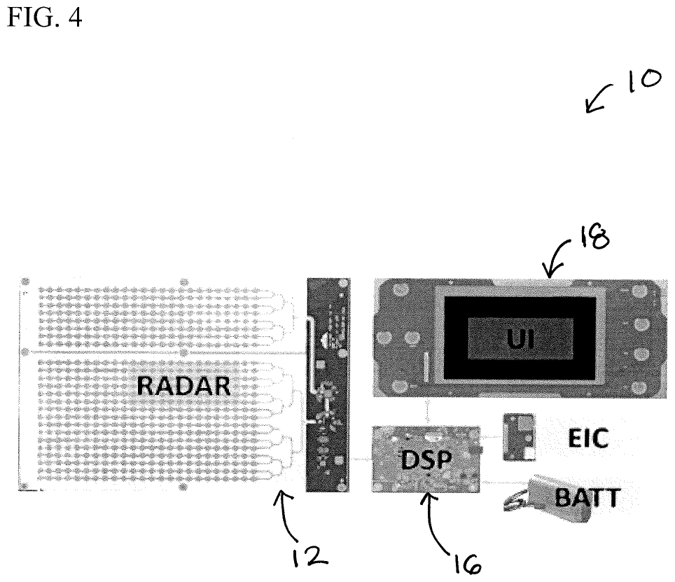

Referring to FIGS. 3-4, the processor 16 of the system 10 includes a printed circuit assembly for short term data storage, high speed digital signal processing, and battery management. In an embodiment, the processor 16 includes a digital signal processing board 28 including a STM32F microcontroller (e.g., a controller, a central processing unit). The processor 16 further includes a memory 30 (e.g., a non-transitory computer-readable storage medium) and a battery management system 32 coupled to a power source (e.g., a battery 34). The battery management system 32 charges the battery 34 of the system 10, and battery management system charges provides regulated power to the processor 16, the radar apparatus 12, and the user interface 18. In an embodiment, the battery 34 is a rechargeable lithium battery pack (e.g., a 7.4V-18.5 Wh Li-Ion Battery Pack) that provides power for the system 10 and may charge during use of the system. The system 10 further includes connector 36 (e.g., USB-C and 2.5 mm stereo external connections) and a charging port 38 (e.g., USB-C charging, power port). The system 10 includes a 2.5 mm input 36 to operably couple the trigger 14 (e.g., a 2.5 mm mechanical recoil trigger). The 2.5 mm mechanical recoil trigger 14 is operably coupled to the processor 16 through the digital signal processing board 28 while the digital signal processing board is further coupled to the user interface 18 and the radar apparatus 12 via the data interface 54. The USB-C port 38 is coupled to the battery management system 32 for recharging the battery 34. The memory 30 of the processor 16 may be a RAM to store radar data. The memory 30 may also include (e.g., store) controller executable instructions for controlling the operation of the system 10 and operable components thereof. The instructions embody one or more of the functional aspects of the system 10 and components thereof, as described herein, with the controller executing the instructions to perform the one or more functional aspects.

The user interface 18 may include Bluetooth radio 40, a display 42 (e.g., LCD display), and actuators of user input (e.g., push button 44). The push buttons 44 allow the operator to input data. For example, referring to FIG. 1, the system 10 includes eight push button controls 44 (e.g., power button, selection button, undo button, up button, down button, left button, right button, and signal button). Further, the system 10 may include protective rubber bumpers 46 to protect the system from impact. The system 10 may also include a ¼-20 thread accessory/mounting inserts 48.

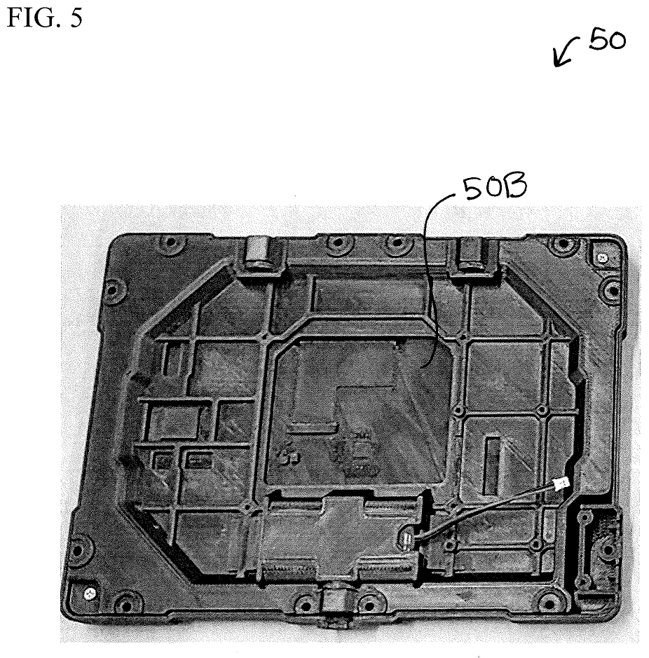

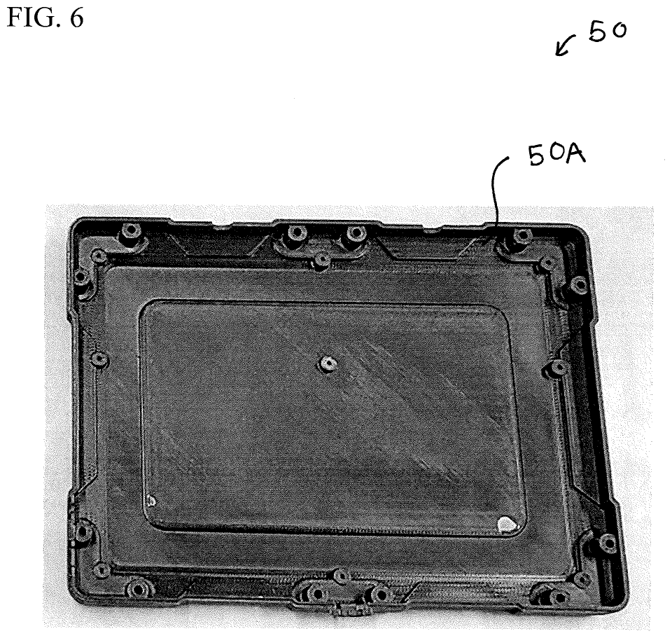

Referring to FIGS. 5-6, the system 10 includes a housing 50 formed of a front housing portion 50A and a back housing portion 50B adapted to be coupled together. The housing 50 includes an interior space between the front and back housing portions 50A, 50B to secure operable components (e.g., the power source 34, the processor 16, the radar apparatus 12, the connector 36, and the port 38, and the user interface 18) of the system 10.

Referring to FIGS. 7 and 8, the system 10 may be placed on or near a shooting bench, for example, even with or behind a front of a muzzle of the firearm F. The system 10 may be supported by a support (e.g., a tripod) coupled to the mounting inserts 48. The system 10 and firearm F should be placed near each other and aligned or in register with a same point of aim (e.g., the chosen target T) some distance away (e.g., 100 yards). For example, when the projectile P is a bullet or pellet from a firearm F, the system 10 may be positioned to the left or right of the firearm.

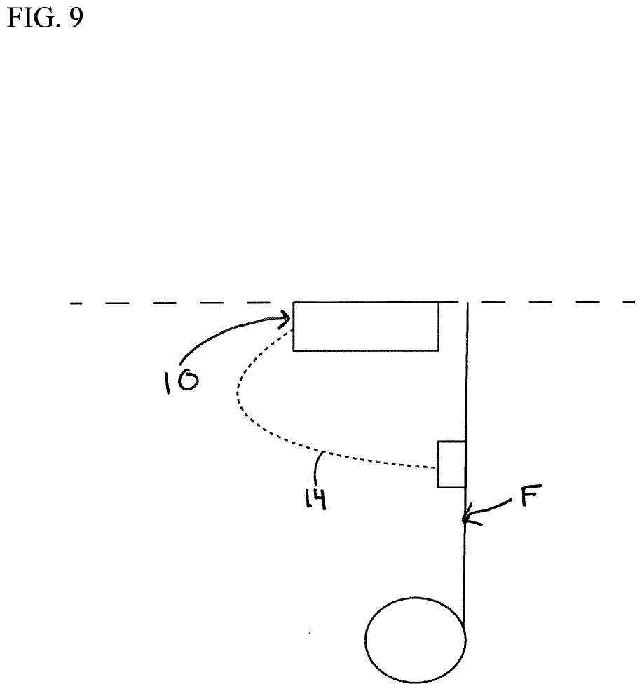

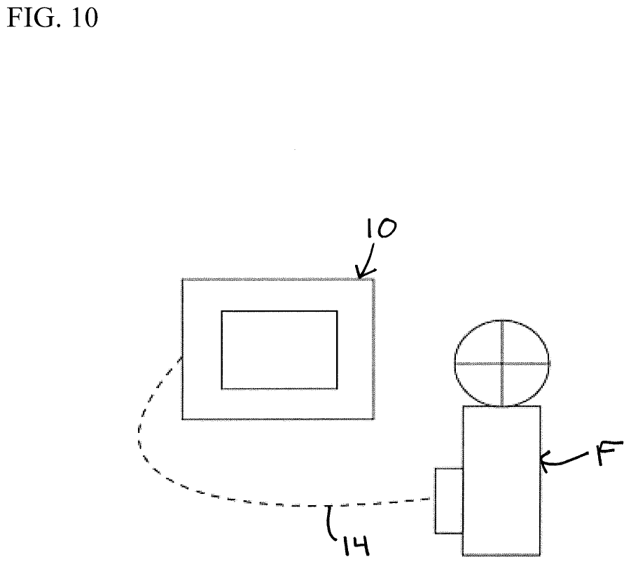

Referring to FIGS. 9 and 10, the trigger 14 is operably coupled to the radar apparatus 12 and the processor 16. The trigger 14 automatically initiates operation of the radar apparatus 12 to transmit a signal, initiates operation of the radar apparatus to receive a reflected signal, and initiate the processor 16 to store the radar data. The trigger 14 is activated by an acoustic, vibrational, or recoil force, or a reflected radar signal. For example, the system 10 may include a 2.5 mm mechanical recoil trigger 14. The mechanical recoil trigger 14 is connected to the 2.5 mm input on the system 10 and coupled to the firearm F and activates in response to the recoil of the firearm after a shot is fired. Alternatively, the trigger 14 may be a spring vibration switch or a microphone that is activated by the acoustic force resulting from the firearm F being fired.

The radar apparatus 12 transmits signals (e.g., high frequency electromagnetic waves). In an embodiment, the radar apparatus 12 transmits a radar signal. The radar signal includes a base radar frequency signal (e.g., a Doppler component) that is frequency shifted (e.g., a chirp component). In an embodiment, the frequency shift may be in a pattern of a sawtooth or triangle chirp signal. The radar signal has a signal profile, generally indicated at reference number 52, in a direction of the chosen target T. The radar apparatus 12 may be a patch antenna used to control shapes control signal profiles 52. In the illustrated embodiment, the transceiver 24 (e.g., 24 GHz radar transceiver) of radar apparatus 12 transmits the frequency shifted radar signal via TX antenna 20 and receives the reflected signal via RX antenna 22. The TX antenna 20 may be a smaller patch array compared to the RX antenna 22. The RX antenna 22 having a larger patch array allows for a greater gain to receive the reflected signal. The 24 GHz radar transceiver 24 may be a digitally controlled transceiver that transmits the radar signal, receives the reflected signals, and mixes the radar signals and reflected signals to provide a lower frequency signal to the processor 16 for processing.

The radar signal includes radar data. The Doppler component of the radar signal from the radar apparatus 12 uses Doppler effect to determine the velocity of projectile P by a frequency shift between the radar signal and the reflected signal. The frequency shift provides velocity data, but does not indicate the range (e.g., position or relative distance) of the projectile P. The shift in frequency is due to a change in frequency of the radar signal in relation to the projectile P, moving relative to the signal. The chirp component as a more sophisticated type of radar signal from the radar apparatus 12, uses the Doppler effect to determine a phase shift (e.g., a time delay) to a repeating chirp pattern to determine the range of the projectile P. The chirp component is used to measure a change in frequency with time. When the radar apparatus 12 is aligned with a muzzle of a firearm F or a measured delta from the muzzle, then velocity of the projectile P can be measured at a known range. The radar data can then be used to more accurately predict the trajectory of bullets of the projectile P, relative distance of the projectile, as well as calculating muzzle velocity and measuring velocity of multiple projectiles traveling together.

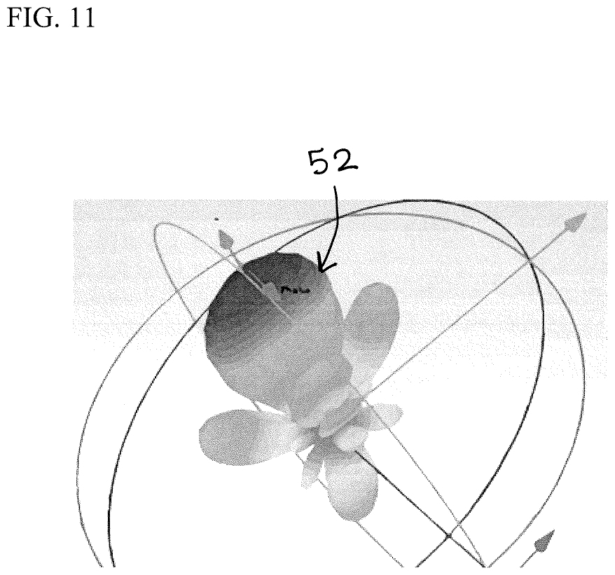

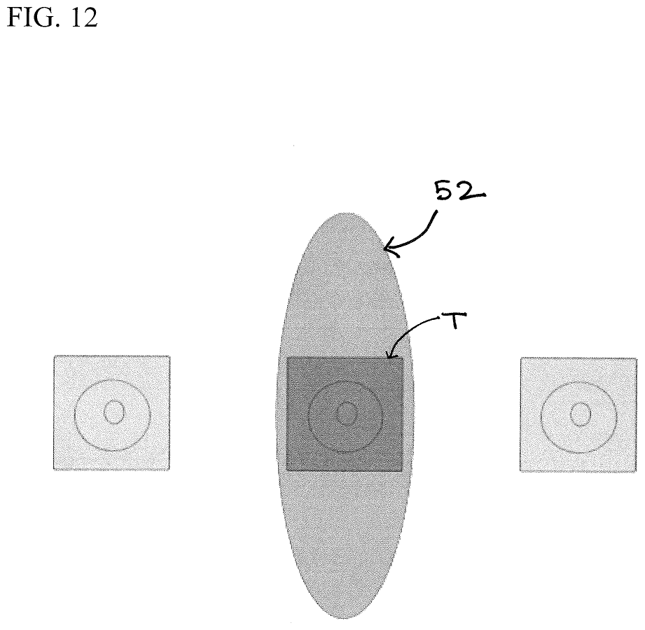

Referring to FIGS. 8, 11, and 12, the signal profile 52 of the radar signal emitted from the radar apparatus 12, generally has a cone shape that gets wider as the signal moves away from the system 10. In order to detect the projectile P, the projectile must pass through the signal profile 52 at some distance away from the muzzle or other point of origin. The radar signal reflects off the projectile P traveling through a portion of the signal profile 52 toward the chosen target. Referring to FIG. 12, the signal profile 52 has a height and a width in a direction transverse to a direction of the height. When measured at the chosen target T, the height is larger than the width. This allows for a higher tolerance for elevation alignment error and vertical drop as opposed to adjacent directions. Referring to FIG. 12, at the chosen target T, the signal profile 52 has a cross section of a vertical ellipse cone covering a larger elevation area than horizontal area. This embodiment design is optimized to reduce a chance for detection of projectiles in shooting lanes adjacent to the target. Other configurations can be used without departing from the present disclosure.

In an embodiment, processor 16 controls the transceiver 24 of radar apparatus 12 via the serial data interface 54. The processor 16 in this embodiment also receives mixed radar output signals and stores the received signals into the memory 30 during acquisition for processing when acquisition is complete. The processor 16 is configured to process the radar data to extract range, velocity, and signal strength sets for ballistic calculation on the serial data interface 54 printed circuit assembly, and receive input signal from the trigger 14. The processor 16 collects the radar data and calculates velocity of the at least one projectile P based thereon.

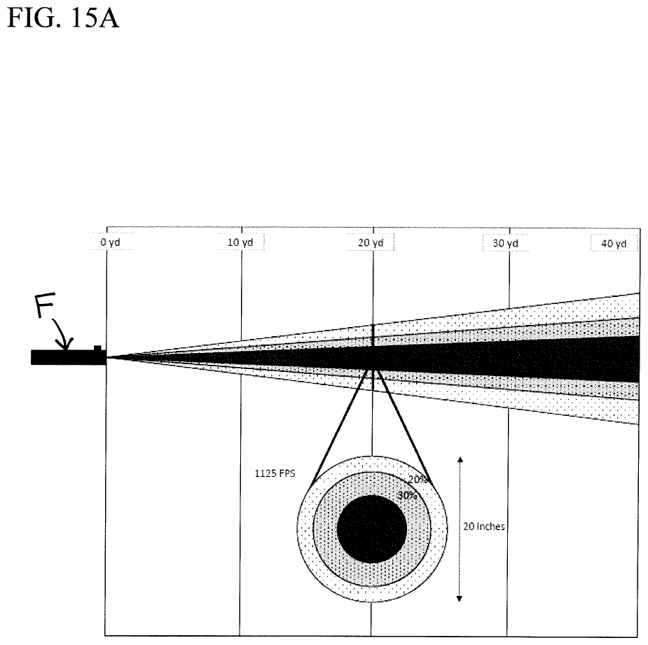

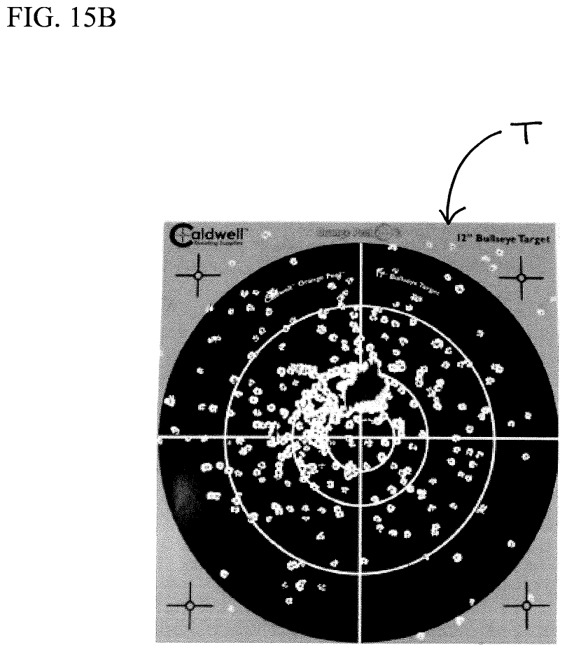

The system 10 may be set to an acquisition mode via the user interface 18. Acquisition mode parameters includes mode projectile type (e.g., rifle, pistol, bow and arrow, shotgun), expected velocity (e.g., less than 1000 fps, 600 to 1600 fps, greater than 1400 fps), and trigger (e.g., acoustic, recoil, radar). When the trigger 14 is detected, the radar apparatus 12 will acquire radar data in a time domain in accordance with the settings. The processor 16 receives the radar data and stores the radar data in the memory 30. Duration of the acquisition is determined based on the expected velocity, the projectile type, and a tracking range (e.g., 100 yards). Once acquisition is complete, the processor 16 processes the data to determine the range, velocity, and signal strength at multiple intervals during flight of the projectile P. Referring to FIG. 2, in the embodiment of a shotgun, 2 to 3 sets of range, velocity, and signal strength may be stored all occurring at a single time interval. At multiple distances (dx) in the flight of the shot cloud, the radar apparatus 12 and the processor 16 will determine a set of distance (dx,1-3), velocity (vx,1-3), and signal strength (sx,1-3). From this data, many characteristics of the shot cloud can be sampled at a point in time/distance (e.g. average velocity, average distance, approximate length (Ldx˜dx,3-dx,1), relative number of pellets in first, second, and third section of a column (sx,y/sx). Additionally, due to multiple samples, characteristics can be fit to a function of distance from the muzzle of the firearm F. The processor 16 may create a matrix of range, velocity, and signal data for the shot cloud and will signal that the radar data ready to be displayed on the user interface 18, which the processor 16 will then download the data and post process for presentation to the operator to include the ballistic curve, muzzle velocity, and other variables important to the operator. Characteristics of shot cloud diameter (Ddx) and the density of pellets cannot be directly measured from the radar data; however, diameter and density may be approximated by a model that uses the measured characteristics and the radar data. Ballistic characteristics of the shot cloud P and diameter model can be presented to the user as a cross sectional ballistic trajectory/spread graph and/or the more traditional shot pattern approximation at a user defined distance, as shown in FIG. 2. Referring to FIG. 15A, the shot pattern approximation may be displayed to the operator on the display 42 (FIG. 1). FIG. 15A represents an approximation of a relative number of pellets within the shot cloud and the pellet's relative range after being fired from the firearm F. Referring to the example shown in FIG. 15A, an extracted region at 20 yards from the firearm F displays that fifty percent of the pellets of the shot cloud will be within a core region, thirty percent of the pellets will be within an intermediate region, and twenty percent of the pellets will be within an outermost region. As the pellets within the shot cloud move in the direction towards the chosen target and away from the firearm F, the pellets within the shot cloud may move farther apart. Similar functions can be used for other types of projectiles. Other types of functions and/or outputs can be used without departing from the scope of the present disclosure. For example, with an input of the projectile's weight, kinetic energy of the projectile may be calculated.

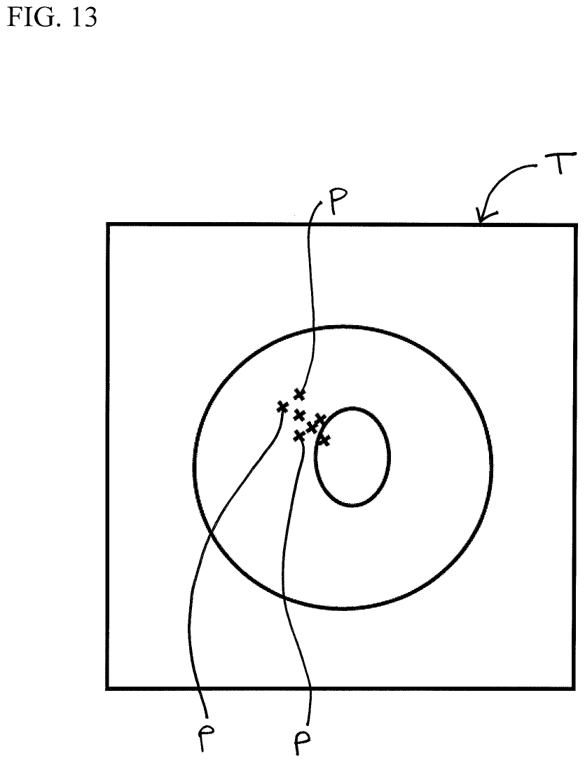

The processor 16 calculates a phase shift between the radar signal and the reflected signal and uses processor algorithms that rely on binning velocity and the radar data of the radar signal and reflected signal that indicate the range of the projectile P to identify the projectile attempting to be measured. Background and any incidental objects (e.g., birds, leaves) are typically moving much more slowly than the projectile P (e.g., a bullet, shot cloud, or other projectile(s)). By narrowing the radar data into one bin, in an expected velocity range, average velocity of the projectile P can be determined more accurately. In the case of a shot cloud, if only one bin is used then the average velocity of the shot cloud can be ascertained. Referring to FIG. 13, multiple radar signal bins close to one another and near a target velocity, which the target velocity can be used to identify more characteristic information about the shot cloud and effectively pattern the shot cloud P. The shot cloud pattern can be displayed on display 42 of the user interface 18 to virtually display to the operator where the pellets within the shot cloud hit on the plane of the chosen target T. The chosen target T may be within a transverse plane compared to the initial point that the shot cloud begins flight such that pellets with the shot cloud are on at different locations on the transverse plane when reaching the chosen target. Each shot pellet within the shot cloud will be moving at a slightly different velocity and slightly different range from one another. When sampled over time, the radar data can be used to indicate the length of the shot cloud, change to shape of the shot cloud over time, and the calculate the average velocity. In addition, a shot cloud model can be applied to the velocity data and overall trajectory to determine characteristics about shot diameter and density (FIG. 2). Referring to FIG. 15B, the different locations the pellets reach the chosen target T may be modeled and may be provided to the operator on the display 42 (FIG. 1) as an illustration indicating the shot pattern. Furthermore, signal to noise (SNR) ratio of the bins can be used to determine a relative number of pellets in each velocity and range bin, further refining a patterning model. Referring again to FIG. 15A, the relative number of pellets within the shot cloud can be modeled throughout their path from the firearm F at different distances (e.g., 10 yards, 20 yards, 30 yards, 40 yards, etc.).

The processor 16 is configured to determine a relative range of the projectile P from the radar apparatus 12 utilizing the radar signal. The processor 16 determines time delay of the reflected signals to determine the range to the projectile P while determining the velocity by calculating a beat frequency. In an embodiment, the base radar frequency signal of radar signal is frequency shifted in a pattern of a sawtooth chirp signal or a triangular chirp signal. A benefit to utilizing a sawtooth chirp signal or a triangular chirp signal is that both velocity and range can be determined from the received signal and does not need to be inferred as with continuous wave radar. Alternatively, other configurations can be used. Referring to FIG. 13, the received signal is a scaled and delayed version of transmitted radar signal with the following equation: x_{R}(t)=α xₜ

$$( t - {t}_{d} ) = α cos ( 2 {π f}_{c} ( t - {t}_{d} ) + \frac{β}{T} {( t - {t}_{d} )}^{2} ) ,$$

wherein α is a path loss attenuation and t_{d} is time delay of the reflected signal. Round-trip delay of the reflected signal is determined by

$${t}_{d} = \frac{2 R}{c} ,$$

wherein R is the relative range of the projectile P and c is the speed of light. Beat frequency is determined as

$${ϕ}_{0} = - 2 π ( \frac{B}{{T}_{c}} {t}_{d} ) t ,$$

through equations:

$$y ( t ) = {x}_{R} ( t ) \times {x}_{T} ( t ) = α cos ( {ϕ}_{0} ( t - {t}_{d} ) \times cos ( {ϕ}_{T} ( t ) ) \\ y ( t ) = \frac{α}{2} [ cos ( {ϕ}_{0} ( t - {t}_{d} ) - {ϕ}_{T} ( t ) ) + cos ( {ϕ}_{0} T ( t - {t}_{d} ) + {ϕ}_{T} ( t ) ) ] .$$

The user interface 18 displays data of the projectile P to the user, presents user menus, and interfaces with an App via Bluetooth 40. In an embodiment, the user interface 18 is configured to display the velocity of the at least one projectile P to an operator. Further, the user interface 18 may display the relative range of the projectile P. The controller of the processor 16 communicates with the user interface 18 to control and configure radar apparatus 12 to retrieve acquired shot data, post processes shot data into ballistic data for presentation to the user, read push buttons, control the display and Bluetooth radio 40. Bluetooth radio 40 in this embodiment permits interfacing to an (optional) Bluetooth companion App on a remote/mobile device, such as a smart phone or tablet.

In one embodiment, the system 10 may be used to monitor at least one projectile P during flight with steps of: triggering the radar apparatus 12 to transmit the radar signal in the direction of the chosen target T, generating the radar signal from the radar apparatus in response to the triggering; acquiring data from the radar signal from the radar apparatus; acquiring data from the reflected signal off the at least one projectile P passing through the signal profiles 52 of the radar signal; and determining velocity of the at least one projectile by binning the radar data. Determining the velocity of the projectile P may include determining a frequency shift between the radar data collected and comparing the radar data to an approximate velocity of the projectile to filter out noise. Initial setup of the system 10 may be required such as, aligning the system with the chosen target and configuring settings of the system 10 to start measurements. Further, in an embodiment, triggering the radar apparatus 12 includes shooting a firearm F in path of the chosen target. Once the radar data is compared to approximate velocity of the projectile P, the method may further include disabling measurement mode and reviewing the approximate velocity of the projectile.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed:

1. A system for monitoring at least one projectile during flight, the system comprising:
a radar apparatus configured to transmit a radar signal, the radar signal comprising a base radar frequency signal with a frequency shift, the radar signal having a signal profile in a direction of a chosen target, wherein the radar signal is configured to reflect off the projectile traveling through at least a portion of the signal profile toward the target, the radar apparatus further configured to receive at least one reflected signal from the projectile, wherein the reflected signal and the radar signal comprise radar data; and
a trigger operably coupled to the radar apparatus, wherein the trigger is configured to automatically initiate operation of the radar apparatus to transmit the radar signal and initiate operation of the radar apparatus to receive the reflected signal; and
a processor configured to collect the radar data and calculate velocity of the projectile based thereon.

2. The system of claim 1, wherein the processor is further configured to determine a relative range of the projectile from the radar apparatus utilizing a phase shift between the radar signal and the reflected signal.

3. The system of claim 2, wherein the frequency shift of the base radar frequency signal is in a pattern comprising at least one of a sawtooth chirp signal and a triangular chirp signal.

4. The system of claim 1, wherein the processor is configured to calculate a frequency shift between the radar signal and the reflected signal for calculating the velocity of the projectile.

5. The system of claim 1, wherein the radar apparatus comprises an aiming device having a peep sight through which an operator is able to view the chosen target.

6. The system of claim 1, wherein the signal profile has a height, and a width in a direction transverse to a direction of the height, wherein the height is larger than the width when measured at the chosen target.

7. The system of claim 1, wherein the signal profile has a cross section of a vertical ellipse, non-circular cone covering a larger elevation area than horizontal area.

8. The system of claim 1, wherein the trigger is activated by a recoil, a vibrational force, an acoustic force, or reflected radar signal.

9. The system of claim 1, wherein the trigger is operably coupled to the processor to automatically initiate the processor to collect the radar data.

10. The system of claim 1, wherein the processor is further configured to calculate a signal strength of the reflected radar signal.

11. The system of claim 1, further comprising a data interface configured to display the velocity of the projectile to an operator.

12. The system of claim 1, wherein the projectile comprises a plurality of pellets being fired simultaneously.

13. A method of monitoring at least one projectile during flight with the system set forth in claim 1, wherein the method comprises:
triggering the radar apparatus to transmit the radar signal in the direction of the chosen target,
generating the radar signal from the radar apparatus in response to the triggering;
acquiring data from the radar signal from the radar apparatus;
acquiring data from the reflected signal off the projectile passing through the signal profile of the radar signal; and
binning the radar data for use of determining the velocity of the projectile.

14. The method of claim 13, wherein determining velocity of the projectile includes determining a frequency shift between the radar data collected.

15. The method of claim 14, wherein determining velocity of the projectile comprises comparing the radar data to an approximate velocity of the projectile to filter out noise.

16. A system for monitoring a plurality of projectiles in a shot cloud during flight, the system comprising:
a radar apparatus configured to transmit a radar signal comprising a base radar frequency signal with a frequency shift, the radar signal having a signal profile in a direction of a chosen target, wherein the radar signal is configured to reflect off the plurality of projectiles within the shot cloud traveling through at least a portion of the signal profile toward the target, the radar apparatus being configured to receive reflected signals from the plurality of projectiles within the shot cloud, wherein the reflected signals and the chirp signal comprise radar data; and
a trigger operably coupled to the radar apparatus, wherein the trigger is configured to automatically initiate operation of the radar apparatus to transmit the radar signal and receive the reflected signals; and
a processor configured to collect the radar data and calculate velocity of two or more of the plurality of projectiles within the shot cloud based thereon.

17. The system of claim 16, wherein the plurality of projectiles within a shot cloud begin flight at a same initial point.

18. The system of claim 16, wherein the processor is configured to determine relative ranges of the plurality of pellets from the radar apparatus utilizing the radar signal.

19. The system of claim 18, wherein the frequency shift of the base radar frequency signal is in a pattern of a sawtooth chirp signal or a triangular chirp signal.

20. The system of claim 16, wherein the processor is configured to determine a frequency shift between the radar signal and each of the reflected signals for calculating relative ranges of the projectiles from the radar apparatus.

21. The system of claim 16, wherein the trigger is activated by a recoil, a vibrational force, an acoustic force, or a reflected radar signal.

22. A chronograph system for monitoring at least one projectile during flight, the chronograph system comprising:
a housing containing a processor configured to calculate a velocity of the projectile based on monitoring the projectile during flight;
an aiming device coupled to the housing, the aiming device comprising a peep sight through which an operator is able to view an intended path of the projectile; and
a trigger operably coupled to the processor, wherein the trigger is configured to automatically initiate operation of the processor for calculating the velocity of the projectile.

23. The chronograph system of claim 22, further comprising a radar apparatus contained in the housing, the radar apparatus configured to transmit a radar signal, the radar signal comprising a base radar frequency signal with a frequency shift, the radar signal having a signal profile in a direction of the intended path of the projectile, wherein the radar signal is configured to reflect off the projectile traveling through at least a portion of the signal profile along the intended path, the radar apparatus further configured to receive at least one reflected signal from the projectile, wherein the reflected signal and the radar signal comprise radar data, and wherein the processor is responsive to the collected radar data for calculating the velocity of the projectile.
